(19) United States
(12) Patent Application Publication
(10) Pub. No.: US 2011/0004814 A1
(43) Pub. Date: Jan. 6, 2011

(54) SEMICONDUCTOR MEMORY APPARATUS AND DATA WRITE METHOD OF THE SAME

(75) Inventor: Choung Ki SONG, Ichon-si (KR)

Correspondence Address: Echelon Law Group, PC, 1919 Gallows Road., Suite 330, Vienna, VA, 22182, US

(73) Assignee: HYNIX SEMICONDUCTOR INC., Ichon-si (KR)

(21) Appl. No.: 12/648,906

(22) Filed: Dec. 29, 2009

(30) Foreign Application Priority Data
Jul. 1, 2009 (KR) 10-2009-0059869

(51) Int. Cl. G06F 11/07

(52) U.S. Cl. 714/799; 714/E11.024

(57) ABSTRACT

A Semiconductor memory apparatus includes: a data latch driving unit configured to latch and drive data and to transfer the driven data via a first data bus, based on a detection start signal and a detection stop signal; a data masking latch driving unit configured to latch and drive a data masking signal and to transfer the driven data masking signal via a second data bus, based on the detection start signal and the detection stop signal; an error detection unit configured to perform an error detection operation on the data and the data masking signal to generate an error detection signal, based on the detection start signal and the detection stop signal; an error detection driving unit configured to drive the error detection signal and to transfer the driven error detection signal via a third data bus; a write control unit configured to generate a write control signal based on the data masking signal transferred via the second data bus and the error detection signal transferred via the third data bus; and a data write unit configured to write aligned data transferred via the first data bus into a core circuit, based on the write control signal.

### CROSS-REFERENCE TO RELATED APPLICATION

The present application claims priority under 35 U.S.C §119(a) to Korean Application No. 10-2009-0059869, filed on Jul. 1, 2009, which is incorporated by reference in its entirety as if set forth in full.

### BACKGROUND OF THE INVENTION

1. Technical Field

Various embodiments of the present disclosure generally relate to a semiconductor memory apparatus, and more particularly, to a data write circuit of the semiconductor memory apparatus.

2. Related Art

A semiconductor memory apparatus typically receives/outputs multi-bit data serially from/to an external memory control apparatus. On the other hand, the semiconductor memory apparatus has a plurality of internal global data buses (GIOs) to receive/output the multi-bit data from/to a core region, and the multi-bit data transferred via the global data buses are parallel data. As such, since the multi-bit data are transferred in parallel in the semiconductor memory apparatus whereas the multi-bit data are transferred serially outside the semiconductor memory apparatus, a data write circuit is needed in the semiconductor memory apparatus to perform an operation to align the serial data in parallel. Afterwards, the data write circuit performs an operation to transfer the data aligned in parallel to the core circuit region via the global data buses.

The semiconductor memory apparatus includes a plurality of data input buffers and thus receives as input a plurality of data through a plurality of pads simultaneously. In addition, the semiconductor memory apparatus includes data masking input buffers that correspond to the respective data input buffers, and receives data masking signals. The data masking signals are necessary to effectively prevent a part of the data bits that are input via the data input buffers from being transferred to the core circuit.

Meanwhile, a typical semiconductor memory apparatus includes a circuit to detect an error in the input data, and determines whether or not any defective bit exists in the input data by using a technique such as a Cyclic Redundancy Check (CRC). Here, not only the input data, but also the data masking signals may have a defective bit. When a defective bit is contained in one of the data masking signals, data that should not have been written to the core circuit may be written to the core circuit, which may cause more serious malfunction than when the defective bit is contained in the input data.

FIG. 1 is a diagram that shows an operation of a data write circuit in a typical semiconductor memory apparatus.

Referring to FIG. 1, for example, the semiconductor memory apparatus receives both sequential 8-bit input data DIN<1:8> and a data masking signal ‘DM’, and then data D_CORE are written into the core circuit. Here, input data (DIN) bits corresponding to enable bits of the data masking signal ‘DM’ are not written into the core circuit, while input data (DIN) bits corresponding to disable bits of the data masking signal ‘DM’ are written into the core circuit. Here, dotted line in the data masking signal ‘DM’ represents that a bit that should have been enabled is erroneously disabled due to an error which has occurred in the data masking signal ‘DM’. Accordingly, in this case, a malfunction that the input data bit, e.g., DIN<3>, that should not have been written into the core circuit is written into the core circuit occurs, which in effect means a malfunction of the data write operation of the semiconductor memory apparatus. Here, an error detection signal ‘ERR’ is not generated until the data including the defective bit are transferred to the core circuit, and the semiconductor memory apparatus cannot effectively prevent the defective data from being written into the core circuit.

When the defective bit is contained in the input data, the memory control apparatus transfers the input data again in response to the error detection signal ‘ERR’ afterwards to solve the problem. However, when the defective bit is contained in the data masking signal ‘DM’ as mentioned above, the input data bit, e.g., DIN<3>, that should not have been written is already input (i.e. written) into the core circuit, which makes it hard to cure the data write operation.

As such, the typical semiconductor memory apparatus cannot effectively prevent the above-mentioned malfunction in the data write operation when an error bit occurs in the data masking signals. Moreover, as the semiconductor memory apparatus operates at high speeds, there is a high probability that the above-mentioned malfunction occurs. However, typical semiconductor memory apparatuses do not have necessary reliability of the data write operation.

### SUMMARY OF THE INVENTION

Accordingly, there is a need for an improved semiconductor memory apparatus and a related driving method that may overcome one or more of the problems discussed above. Therefore, various embodiments of the present invention may provide a semiconductor memory apparatus that is capable of improving reliability of a data write operation and a data write method thereof.

To attain the advantages and in accordance with the purposes of the invention, as embodied and broadly described herein, one exemplary aspect of the present invention may provide a semiconductor memory apparatus comprising: a data latch driving unit configured to latch input data and to transfer the latched input data based on a detection start signal and a detection stop signal; a data masking latch driving unit configured to latch a data masking signal and to transfer the latched data masking signal based on the detection start signal and the detection stop signal; an error detection unit configured to perform an error detection operation on the input data and the data masking signal and generate an error detection signal, based on the detection start signal and the detection stop signal; an error detection driving unit configured to drive the error detection signal and to transfer the driven error detection signal; a write control unit configured to generate a write control signal based on the data masking signal and the error detection signal; and a data write unit configured to write aligned data transferred, based on the write control signal.

In another aspect, the invention may provide a semiconductor memory apparatus comprising: a data latch driving unit configured to latch and drive data and to transfer the driven data via a first data bus, based on a detection start signal, a detection stop signal, and an error detection signal; a data masking latch driving unit configured to latch and drive a data masking signal and to transfer the driven data masking signal via a second data bus, based on the detection start signal, the detection stop signal, and the error detection signal; an error detection unit configured to perform an error detection operation on the data and the data masking signal to generate the error detection signal, based on the detection start signal and the detection stop signal; and a data write unit configured to write the data transferred via the first data bus into the core circuit, based on the data masking signal transferred via the second data bus.

In still another aspect, the invention may provide a data write method of a semiconductor memory apparatus comprising: enabling a detection start signal and latching data and a data masking signal, respectively; performing an error detection operation on the data and the data masking signal to generate an error detection signal; enabling an detection stop signal and driving the latched data and the latched data masking signal and the error detection signal, respectively, and transferring the driven data and the driven signals via corresponding data buses; and controlling the data transferred via the data bus to be written, based on the error detection signal and the data masking signal transferred via the corresponding data buses.

In still another aspect, the present invention may provide a data write method of a semiconductor memory apparatus comprising: enabling a detection start signal and latching data and a data masking signal, respectively; performing an error detection operation on the data and the data masking signal to generate an error detection signal; enabling an detection stop signal, and then, based on whether or not the error detection signal is enabled, driving the latched data and the latched data masking signal and transferring the driven data and the driven data masking signal via corresponding data buses; and controlling the data transferred via the data bus to be written into the core circuit, based on the data masking signal transferred via the data bus.

Additional objects and advantages of the invention will be set forth in part in the description which follows, and in part will be obvious from the description, or may be learned by practice of the invention. The objects and advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate various embodiments consistent with the invention and, together with the description, serve to explain the principles of the invention.

FIG. 1 is a diagram that shows an operation of a data write circuit of a typical semiconductor memory apparatus.

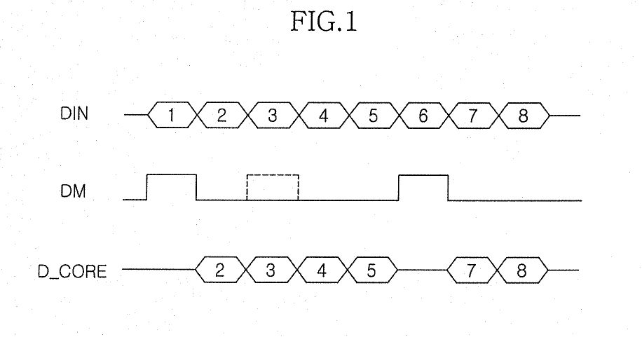

FIG. 2 is a block diagram that shows an exemplary configuration of a semiconductor memory apparatus according to an aspect of the present invention.

FIG. 3 is a diagram that shows an exemplary configuration of an aspect of a data latch driving unit of FIG. 2.

FIG. 4 is a block diagram that shows an exemplary configuration of a semiconductor memory apparatus according to another aspect of the present invention.

FIG. 5 is a diagram that shows an exemplary configuration of an aspect of a data latch driving unit of FIG. 4.

### DETAILED DESCRIPTION OF THE PREFERRED EMBODIMENTS

Reference will now be made in detail to the exemplary embodiments consistent with the present disclosure, examples of which are illustrated in the accompanying drawings. Wherever possible, the same reference characters will be used throughout the drawings to refer to the same or like parts.

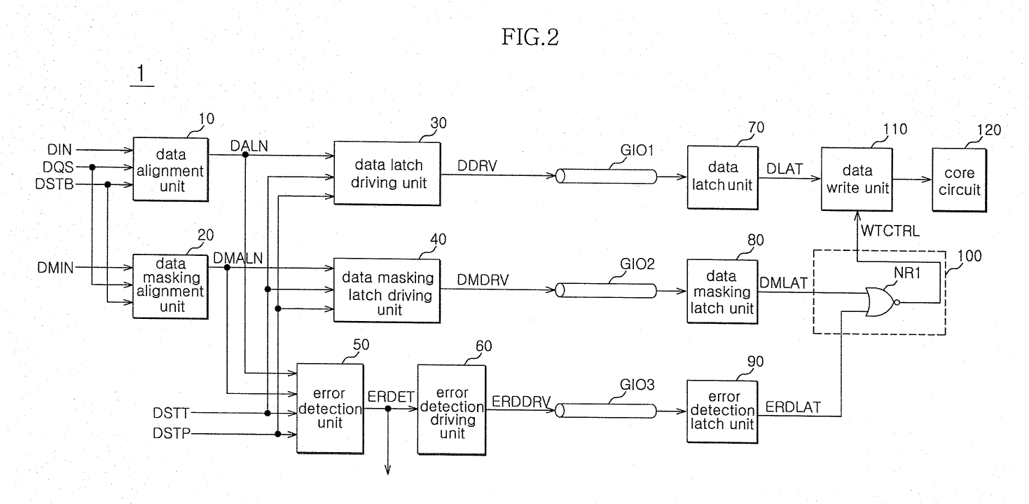

FIG. 2 is a block diagram showing an exemplary configuration of a semiconductor memory apparatus 1 according to an aspect of the present invention.

As shown in FIG. 2, the semiconductor memory apparatus 1 according to one aspect includes a data alignment unit 10, a data masking alignment unit 20, a data latch driving unit 30, and a data masking latch driving unit 40. The data alignment unit 10 aligns serially inputted multi-bit input data DIN in parallel to generate aligned data DALN, in response to a data strobe clock ‘DQS’ and a data input strobe signal ‘DSTB’. The data masking alignment unit 20 aligns a multi-bit input data masking signal ‘DMIN’, which is serially inputted, in parallel to generate an aligned data masking signal ‘DMALN’, in response to the data strobe clock ‘DQS’ and the data input strobe signal ‘DSTB’. In response to a detection start signal ‘DSTT’ and a detection stop signal ‘DSTP’, the data latch driving unit 30 latches and drives the aligned data ‘DALN’ to generate driven data DDRV, and then transfers the driven data ‘DDRV’ via a first data bus GIO1. In response to the detection start signal ‘DSTT’ and the detection stop signal ‘DSTP’, the data masking latch driving unit 40 latches and drives the aligned data masking signal ‘DMALN’ to generate a driven data masking signal ‘DMDRV’, and then transfers the driven data masking signal ‘DMDRV’ via a second data bus GIO2.

In addition, the semiconductor memory apparatus 1 includes an error detection unit 50, an error detection driving unit 60, a data latch unit 70, a data masking latch unit 80, an error detection latch unit 90, a write control unit 100, and a data write unit 110. The error detection unit 50 performs an error detection operation on the aligned data ‘DALN’ and the aligned data masking signal ‘DMALN’ to generate an error detection signal ‘ERDET’, in response to the detection start signal ‘DSTT’ and the detection stop signal ‘DSTP’. The error detection driving unit 60 drives the error detection signal ‘ERDET’ to generate a driven error detection signal ‘ERDDRV’, and then transfers the driven error detection signal ‘ERDDRV’ via a third data bus GIO3. The data latch unit 70 latches the driven data ‘DDRV’ transferred via the first data bus GIO1 to generate latched data ‘DLAT’. The data masking latch unit 80 latches the driven data masking signal ‘DMDRV’ transferred via the second data bus GIO2 to generate a latched data masking signal ‘DMLAT’. The error detection latch unit 90 latches the driven error detection signal ‘ERDDRV’ transferred via the third data bus GIO3 to generate a latched error detection signal ‘ERDLAT’. The write control unit 100 generates a write control signal ‘WTCTRL’ in response to the latched data masking signal ‘DMLAT’ and the latched error detection signal ‘ERDLAT’. The data write unit 110 writes the latched data DLAT into a core circuit 120 in response to the write control signal ‘WTCTRL’.

A clock domain that includes the data strobe clock ‘DQS’ is different from a clock domain that includes the data input strobe signal ‘DSTB’. Here, the data strobe clock ‘DQS’ is a clock signal input through one or more pads and the data input strobe signal ‘DSTB’ is a signal generated from an internal clock. The data alignment unit 10 aligns the input data DIN in parallel in response to the data strobe clock ‘DQS’, and latches the aligned data to generate the aligned data ‘DALN’ in response to the data input strobe signal ‘DSTB’. Also, the data masking alignment unit 20 performs similar operations to those of the data alignment unit 10, and generates the aligned data masking signal ‘DMALN’.

The detection start signal ‘DSTT’ is a signal that starts an operation of the error detection unit 50, and the detection stop signal ‘DSTP’ is a signal that is generated by delaying the detection start signal ‘DSTT’ using a replica delay element (not shown) that is to be enabled when the operation of the error detection unit 50 is completed. The data latch driving unit 30 latches the aligned data ‘DALN’ when the detection start signal ‘DSTT’ is enabled, and drives the latched data to generate the driven data ‘DDRV’ when the detection stop signal ‘DSTP’ is enabled. Similarly, the data masking latch driving unit 40 latches the aligned data masking signal ‘DMALN’ when the detection start signal ‘DSTT’ is enabled, and drives the latched data masking signal to generate the driven data masking signal ‘DMDRV’ when the detection stop signal ‘DSTP’ is enabled. Likewise, the error detection unit 50 operates in response to the detection start signal ‘DSTT’ and the detection stop signal ‘DSTP’. Here, the error detection unit 50 generates the error detection signal ‘ERDET’, which is transferred to a memory control apparatus external to the semiconductor memory apparatus as well.

Although the semiconductor memory apparatus 1 according to one aspect of the invention includes the data latch unit 70, the data masking latch unit 80, and the error detection latch unit 90, those latch units can be omitted depending on circuit implementations.

As shown in FIG. 2, the write control unit 100 can be implemented with a first NOR gate NR1, and disables the write control signal ‘WTCTRL’ when the error detection unit 50 detects an error and the latched error detection signal ‘ERDLAT’ is enabled. Accordingly, the data write unit 110 stops an operation to write the latched data DLAT into the core circuit 120.

On the other hand, when the latched error detection signal ‘ERDLAT’ is disabled, the write control unit 100 inverts and drives the latched data masking signal ‘DMLAT’ to generate the write control signal ‘WTCTRL’, and the data write unit 110 writes the latched data DLAT into the core circuit 120.

Here, the semiconductor memory apparatus 1 according to the aspect of the present invention effectively prevents the aligned data ‘DALN’ and the aligned data masking signal ‘DMALN’ from being transferred to the corresponding data buses until the error detection operation in the error detection unit 50 is completed. Afterwards, when the error detection operation is completed, the semiconductor memory apparatus 1 drives the aligned data ‘DALN’ and the aligned data masking signal ‘DMALN’, respectively, and then transfers the driven data ‘DDRV’ and the driven data masking signal ‘DMDRV’ via the corresponding data buses. At this time, when an error is detected from the aligned data ‘DALN’ and/or the aligned data masking signal ‘DMALN’ and the error detection signal ‘ERDET’ is enabled, the semiconductor memory apparatus 1 effectively prevents the driven data ‘DDRV’ from being written into the core circuit 120. In this way, the semiconductor memory apparatus 1 can effectively prevent the malfunction of undesired data being written into the core circuit 120 when the data masking signal includes a defective bit.

It should be understood that the various control and data signals described herein are meant to include multiple bits of data and signals as well as single bit data and signals. One example may include a case where the latched data ‘DLAT’ are 64-bit data, the latched data masking signal ‘DMLAT’ is an 8-bit signal, and the latched error detection signal ‘ERDLAT’ is a one-bit signal. In the exemplary case, the write control unit 100 may comprise eight NOR gates NR1 each of which receives one of the 8-bit latched data masking signal ‘DMLAT’ and the one-bit latched error detection signal ‘ERDLAT’ as inputs. In the case, the write control unit 100 may output the 8-bit write control signal ‘WTCTRL’, and the data write unit 110 may receive 64 bit-data of the latched data ‘DLAT’ to output 64-bit data to the core circuit 120, with each eight bits of the 64-bit data of the latched data ‘DLAT’ being controlled by one bit of the 8-bit write control signal ‘WTCTRL’. Person skilled in the art would appreciate that the number of bits of various control and data signals described herein can be varied in accordance with the particular implementation.

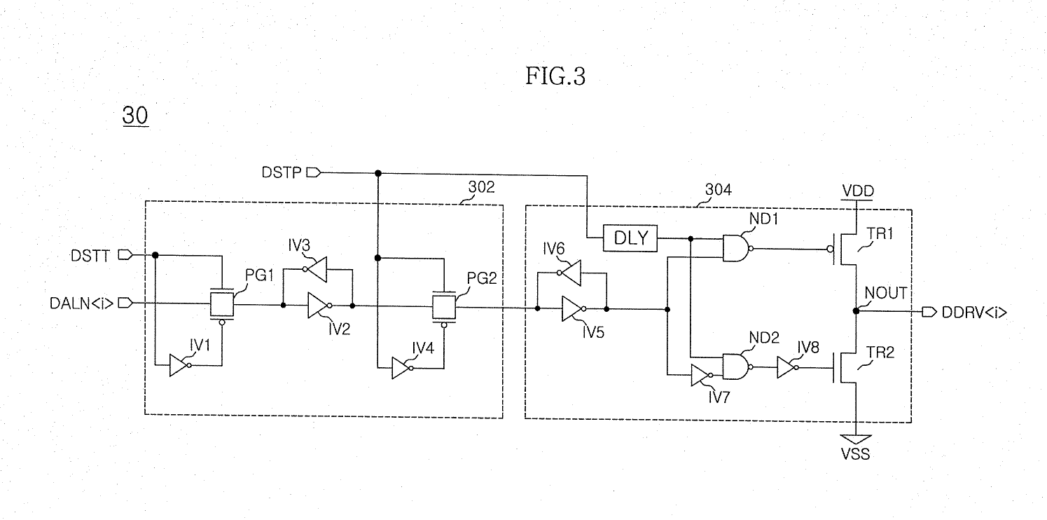

FIG. 3 is a diagram that shows an exemplary configuration of an embodiment of the data latch driving unit 30 of FIG. 2, where a single bit DALN<i> among the multi-bit aligned data ‘DALN’ is latched and driven as an example.

As shown in FIG. 3, the data latch driving unit 30 includes a latch unit 302 and a driving unit 304. The latch unit 302 latches the aligned data DALN<i> in response to the detection start signal ‘DSTT’ and the detection stop signal ‘DSTP’. In response to the detection stop signal ‘DSTP’, the driving unit 304 drives a signal transferred from the latch unit 302 and then generates the driven data DDRV<i>.

The latch unit 302 includes: a first inverter IV1 configured to receive the detection start signal ‘DSTT’; a first pass gate PG1 configured to transfer the aligned data DALN<i> in response to the detection start signal ‘DSTT’ and an output signal of the first inverter IV1; a second inverter IV2 configured to receive a signal transferred from the first pass gate PG1; a third inverter IV3 coupled to the second inverter IV2 in a latch configuration; a fourth inverter IV4 configured to receive the detection stop signal ‘DSTP’; and a second pass gate PG2 configured to transfer an output signal of the second inverter IV2 in response to the detection stop signal ‘DSTP’ and an output signal of the fourth inverter IV4.

In addition the driving unit 304 includes: an output node NOUT configured to output the driven data DDRV<i>; a fifth inverter IV5 configured to receive a signal transferred from the latch unit 302; a sixth inverter IV6 coupled to the fifth inverter IV5 in a latch configuration; a delay element DLY configured to delay the detection stop signal ‘DSTP’; a first NAND gate ND1 configured to receive an output signal of the delay element DLY and an output signal of the fifth inverter IV5; a seventh inverter IV7 configured to receive the output signal of the fifth inverter IV5; a second NAND gate ND2 configured to receive the output signal of the delay element DLY and an output signal of the seventh inverter IV7; an eighth inverter IV8 configured to receive an output signal of the second NAND gate ND2; a first transistor TR1 configured to have a gate terminal to which an output signal of the first NAND gate ND1 is input, a source terminal to which an external power supply voltage VDD is applied and a drain terminal coupled to the output node NOUT; and a second transistor TR2 configured to have a gate terminal to which an output signal of the eighth inverter IV8 is input, a drain terminal coupled to the output node NOUT and a source terminal coupled to the ground.

In such a configuration, the data latch driving unit 30 latches the aligned data DALN<i> when the detection start signal ‘DSTT’ is enabled, and cannot drive data latched in the latch unit 302 until the detection stop signal ‘DSTP’ is enabled. Afterwards, when the detection stop signal ‘DSTP’ is enabled, the driving unit 304 drives the data latched in the latch unit 302, and thus the driven data DDRV<i> is loaded on the first data bus GIO1. Here, the delay element DLY in the driving unit 304 is implemented to effectively prevent an undesired signal from being driven and output from the driving unit 304 immediately after the detection stop signal ‘DSTP’ is enabled.

Meanwhile, since the data masking latch driving unit 40 can be implemented having substantially similar configuration to that of the data latch driving unit 30, those skilled in the art will easily implement the configuration, and detailed description thereof will be omitted.

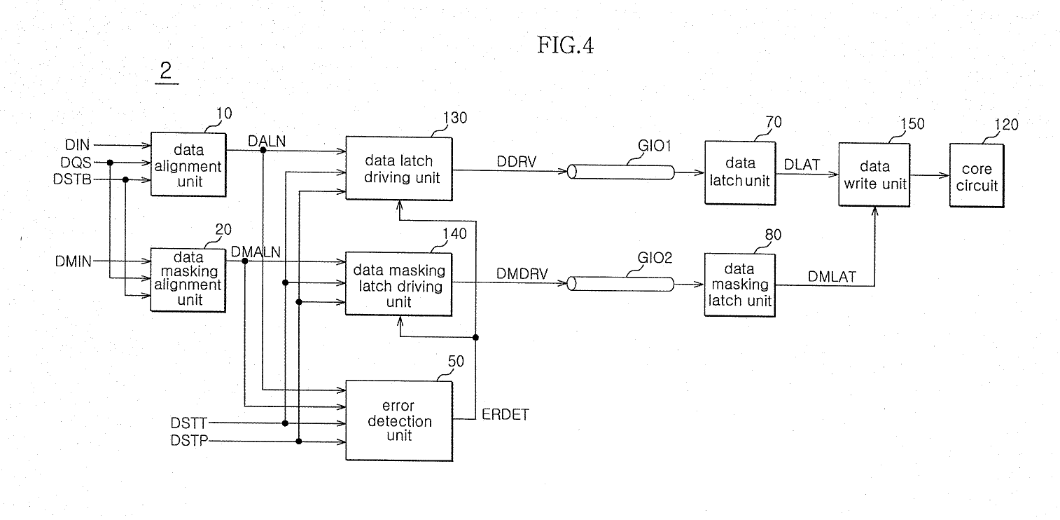

FIG. 4 is a block diagram that shows an exemplary configuration of a semiconductor memory apparatus 2 according to another aspect of the present invention.

Referring to FIG. 4, the semiconductor memory apparatus 2 according to another aspect of the invention does not include the error detection driving unit 60, the error detection latch unit 90, and the write control unit 100 which are included in the above-described aspect of the invention. Another difference from the above-described aspect is that a data latch driving unit 130 and a data masking latch driving unit 140, respectively, receive an error detection signal ‘ERDET’ and a data write unit 150 operates in response to the latched data masking signal ‘DMLAT’.

In detail, the data latch driving unit 130 operates in response to the detection start signal ‘DSTT’ and the detection stop signal ‘DSTP’ as the above-described aspect of the invention, except that the data latch driving unit 130 stops driving internally latched data when the error detection signal ‘ERDET’ is enabled even though the detection stop signal ‘DSTP’ is enabled. As described with respect to the data latch driving unit 130, the data masking latch driving unit 140 also selectively performs the driving operation based on whether the error detection signal ‘ERDET’ is enabled or not.

Therefore, the semiconductor memory apparatus 2 according to another aspect of the present invention effectively prevent the data from being transferred to the data bus when an error is detected in the error detection unit 50, and thus the defective bit of the data is not written into the core circuit 120, and can reduce a current consumption during the time when the data are transferred via the data bus.

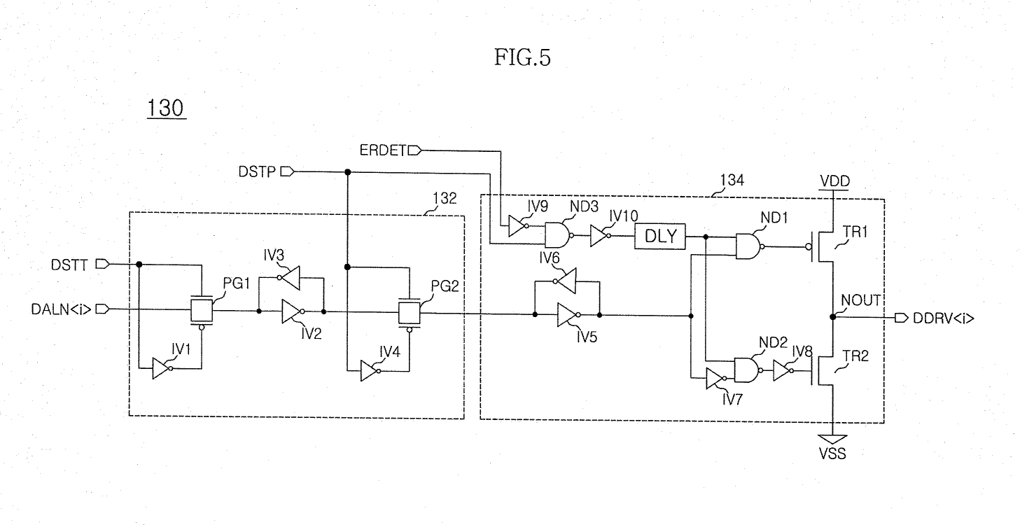

FIG. 5 is a diagram that shows an exemplary configuration of an embodiment of the data latch driving unit 130 of FIG. 4.

As shown in FIG. 5, the data latch driving unit 130 includes a latch unit 132 and a driving unit 134, and has substantially similar configuration as the data latch driving unit 30 of FIG. 3 with like elements of the data latch driving unit 130 of FIG. 5 being given like reference numerals as those of the data latch driving unit 30 of FIG. 3. One feature of the aspect of the present invention is that the driving unit 134 further includes, in front of the delay element DLY, a ninth inverter IV9 configured to receive the error detection signal ‘ERDET’, a third NAND gate ND3 configured to receive the detection stop signal ‘DSTP’ and an output signal of the ninth inverter IV9, and a tenth inverter IV10 configured to invert an output signal of the third NAND gate ND3 and transfer the inverted signal to the delay element DLY.

In this configuration, the data latch driving unit 130 latches the aligned data DALN<i> when the detection start signal ‘DSTT’ is enabled, and cannot drive the latched data when the error detection signal ‘ERDET’ is enabled even though the detection stop signal ‘DSTP’ is enabled.

Here, since the data masking latch driving unit 140 is also implemented having substantially similar configuration as that of the data latch driving unit 130, detailed description thereof will be omitted as well.

As described above, the semiconductor memory apparatus and the data write method thereof according to the embodiments delay writing the data until the error detection operation is completed, and thus can effectively prevent that undesired data are written into the core circuit due to the defective data masking signal. Afterwards, the semiconductor memory apparatus and the data write method thereof according to the embodiments perform the data write operation when there is no error in the data and the data masking signal, and do not perform the data write operation when there is an error in the data and/or the data masking signal. Therefore, the semiconductor memory apparatus and the data write method thereof according to the embodiments can effectively prevent the defective data bit from being written into the core circuit, thereby improving the reliability of the data write operation.

While certain embodiments have been described above, it will be understood to those skilled in the art that the embodiments described are by way of example only. Accordingly, the device and method described herein should not be limited based on the described embodiments. Rather, the apparatus described herein should only be limited in light of the claims that follow when taken in conjunction with the above description and accompanying drawings.

What is claimed is:

1. A semiconductor memory apparatus comprising:
a data latch driving unit configured to latch input data and to transfer the latched input data based on a detection start signal and a detection stop signal;
a data masking latch driving unit configured to latch a data masking signal and to transfer the latched data masking signal based on the detection start signal and the detection stop signal;
an error detection unit configured to perform an error detection operation on the input data and the data masking signal and generate an error detection signal, based on the detection start signal and the detection stop signal;
an error detection driving unit configured to drive the error detection signal and to transfer the driven error detection signal;
a write control unit configured to generate a write control signal based on the data masking signal and the error detection signal; and
a data write unit configured to write aligned data transferred into a core circuit, based on the write control signal.

2. The semiconductor memory apparatus of claim 1, wherein the data latch driving unit is configured to latch the input data when the detection start signal is enabled, and to drive and output the latched input data when the detection stop signal is enabled.

3. The semiconductor memory apparatus of claim 1, wherein the data latch driving unit includes:
a latch unit configured to latch the input data based on the detection start signal and the detection stop signal; and
a driving unit configured to drive and output a signal transferred from the latch unit, based on the detection stop signal.

4. The semiconductor memory apparatus of claim 1, wherein the data masking latch driving unit is configured to latch the data masking signal when the detection start signal is enabled, and to drive and output the latched data masking signal when the detection stop signal is enabled.

5. The semiconductor memory apparatus of claim 1, wherein the data masking latch driving unit includes:
a latch unit configured to latch the data masking signal based on the detection start signal and the detection stop signal; and
a driving unit configured to drive and output a signal transferred from the latch unit, based on the detection stop signal.

6. The semiconductor memory apparatus of claim 1, wherein the write control unit is configured to disable the write control signal when the error detection signal is enabled, and to drive the data masking signal to generate the write control signal when the error detection signal is disabled.

7. The semiconductor memory apparatus of claim 1,
wherein the data write unit is configured to write the input data into the core circuit when the write control signal is enabled, and to stop the data write operation when the write control signal is disabled.

8. The semiconductor memory apparatus of claim 1,
wherein the semiconductor memory apparatus further includes:
a data alignment unit configured to align multi-bit input data input serially in parallel to transfer the aligned data to the data latch driving unit, based on a data strobe clock and a data input strobe signal; and
a data masking alignment unit configured to align a multi-bit input data masking signal input serially in parallel to transfer the aligned data masking signal to the data masking latch driving unit, based on the data strobe clock and the data input strobe signal.

9. A semiconductor memory apparatus comprising:
a data latch driving unit configured to latch and drive data to transfer the driven data via a first data bus, based on a detection start signal, a detection stop signal, and an error detection signal;
a data masking latch driving unit configured to latch and drive a data masking signal and to transfer the driven data masking signal via a second data bus, based on the detection start signal, the detection stop signal, and the error detection signal;
an error detection unit configured to perform an error detection operation on the data and the data masking signal to generate the error detection signal, based on the detection start signal and the detection stop signal; and
a data write unit configured to write the data transferred via the first data bus, based on the data masking signal transferred via the second data bus.

10. The semiconductor memory apparatus of claim 9, wherein the data latch driving unit is configured to latch the data when the detection start signal is enabled, and to drive and output the latched data when the detection stop signal is enabled and the error detection signal is disabled.

11. The semiconductor memory apparatus of claim 9, wherein the data latch driving unit includes:
a latch unit configured to latch the data based on the detection start signal and the detection stop signal; and
a driving unit configured to drive and output a signal transferred from the latch unit, based on the detection stop signal and the error detection signal.

12. The semiconductor memory apparatus of claim 9, wherein the data masking latch driving unit is configured to latch the data masking signal when the detection start signal is enabled, and to drive and output the latched data masking signal when the detection stop signal is enabled and the error detection signal is disabled.

13. The semiconductor memory apparatus of claim 9, wherein the data masking latch driving unit includes:
a latch unit configured to latch the data masking signal based on the detection start signal and the detection stop signal; and
a driving unit configured to drive and output a signal transferred from the latch unit, based on the detection stop signal and the error detection signal.

14. The semiconductor memory apparatus of claim 9, wherein the data write unit is configured to write the data transferred via the first data bus into the core circuit when the data masking signal transferred via the second data bus is enabled, and to stop the data write operation when the data masking signal transferred via the second data bus is disabled.

15. The semiconductor memory apparatus of claim 9, wherein the semiconductor memory apparatus further includes:
a data alignment unit configured to align multi-bit input data input serially in parallel to transfer the aligned data to the data latch driving unit, based on a data strobe clock and a data input strobe signal; and
a data masking alignment unit configured to align a multi-bit input data masking signal input serially in parallel to transfer the aligned data masking signal to the data masking latch driving unit, based on the data strobe clock and the data input strobe signal.

16. A data write method of a semiconductor memory apparatus comprising:
enabling a detection start signal and latching data and a data masking signal, respectively;
performing an error detection operation on the data and the data masking signal to generate an error detection signal;
enabling an detection stop signal and driving the latched data and the latched data masking signal and the error detection signal, respectively, and transferring the driven data and the driven signals via corresponding data buses; and
controlling the data transferred via the data bus to be written, based on the error detection signal and the data masking signal transferred via the corresponding data buses.

17. The data write method of claim 16, wherein controlling the data transferred via the data bus are written includes:
disabling a write control signal when the error detection signal is enabled, and driving the data masking signal to generate the write control signal when the error detection signal is disabled; and
writing the data when the write control signal is enabled, and stopping the data write operation when the write control signal is disabled.

18. The data write method of claim 16, wherein the data write method further includes:
aligning multi-bit input data input serially and a multi-bit input data masking signal input serially in parallel, respectively, to output the data and the data masking signal, respectively, based on a data strobe clock and a data input strobe signal, before enabling the detection start signal and latching the data and the data masking signal, respectively.

19. A data write method of a semiconductor memory apparatus comprising:
enabling a detection start signal and latching data and a data masking signal, respectively;
performing an error detection operation on the data and the data masking signal to generate an error detection signal;
enabling an detection stop signal, and then, based on whether or not the error detection signal is enabled, driving the latched data and the latched data masking signal and transferring the driven data and the driven data masking signal via corresponding data buses; and
controlling the data transferred via the data bus to be written, based on the data masking signal transferred via the data bus.

20. The data write method of claim 19, wherein transferring the driven data and the driven data masking signal via the corresponding data buses includes:
driving the latched data and the latched data masking signal, respectively, when the error detection signal is disabled, and stopping driving the latched data and the latched data masking signal when the error detection signal is enabled.

21. The data write method of claim 19, wherein the data write method further includes:
aligning multi-bit input data input serially and a multi-bit input data masking signal input serially in parallel, respectively, to output the data and the data masking signal, respectively, based on a data strobe clock and a data input strobe signal, before enabling the detection start signal and latching the data and the data masking signal, respectively.
